(19) United States
(12) Patent Application Publication
(10) Pub. No.: US 2012/0328172 A1
(43) Pub. Date: Dec. 27, 2012

(54) APPARATUS AND METHOD FOR DETERMINING PADDING LENGTH

(75) Inventors: Mingliang PAN, Beijing (CN); Xin CHEN, Beijing (CN)

(73) Assignees: Toshiba Medical Systems Corporation, Otawara-shi (JP); Kabushiki Kaisha Toshiba, Tokyo (JP)

(21) Appl. No.: 13/529,173

(22) Filed: Jun. 21, 2012

(30) Foreign Application Priority Data
Jun. 21, 2011 (CN) 201110190120.9

(51) Int. Cl. G06K 9/40; G06K 9/00

(52) U.S. Cl. 382/128; 382/260

(57) ABSTRACT

The present invention discloses an apparatus and method for determining a padding length and an image processing method and apparatus. The apparatus for determining the padding length of an image in an image filtering direction may include an aliasing effect function obtaining unit for obtaining an aliasing effect function of a frequency domain filter for the image, wherein the aliasing effect function is a function representing spatial domain variation of an aliasing effect caused by a frequency domain filtering processing; and a padding length determination unit for determining the padding length for the image in the image filtering direction based on the aliasing effect function. Thereby the aliasing effect can be substantially eliminated and the amount of calculation may be reduced.

### CROSS-REFERENCE TO RELATED APPLICATIONS

This application is based upon and claims the benefit of priority from Chinese Patent Application No. 201110190120.9, filed on Jun. 21, 2011, the entire contents of which are incorporated herein by reference.

### FIELD

The present invention relates generally to the field of computers, and more particularly to an apparatus and method for determining, during an image filtering, the padding length of the image in an image filtering direction and an image processing method and apparatus using the foregoing apparatus and method.

### BACKGROUND

In order to smooth an image, generally a filtering processing may be performed on the image in existing image processing techniques.

In a commonly used filtering processing, an image is first transformed from the spatial domain to the frequency domain through Discrete Fourier Transformation (DFT). Then, the transformed image is filtered in the frequency domain using a filter function. Specifically, the filtering processing may include applying the filter function to the image. For instance, in the frequency domain, the filter function may be applied to the image by multiplying the filter function by an image function (equivalent to the implementation of a circular convolution in the spatial domain). And at last, the filtered image is transformed back to the spatial domain through an inverse Fourier transformation. In this way, the image is smoothed.

In order to avoid the aliasing effect (the aliasing effect is substantially caused by the interference between the rear part and the head part of the image which are adjacent to each other during circular convolution) caused by the application of a filter to the image (equivalent to circular convolution in the spatial domain) when the image is filtered by the filter, the image may be expanded, and the expanded image position may be padded with a rational value (e.g. an image value 0).

For instance, in the case where the length of an image in a filtering direction is A and the length of a filter is B, in order to eliminate the aliasing effect completely, it is necessary to at least expand, starting from the ending part of the image, the image to a length of A+B−1 in the filtering direction and pad the expanded position with a rational image value. For instance, in the case where an image value 0 is set for all the expanded image parts with a padding length B−1, the image positions with the value 0 at the rear part of the image cause no interference to the head part of the image during a filtering processing in the frequency domain, thus eliminating an aliasing effect. In addition, in a specific example, if the length of the image in a filtering direction and the length of the filter both are A, then it is necessary to expand the image to a length of 2*A−1 in the filtering direction starting from the ending part of the image. In this case, the padding length of the image is A−1.

As the length of a filter is generally the same as that of an image in commonly used filtering processing, a large amount of calculation is resulted from the above-described filtering processing since it is necessary to perform a Fourier transformation and an inverse Fourier transformation on the image that is expanded almost twice in length (e.g. the foregoing length 2*A−1).

### BRIEF DESCRIPTION OF THE DRAWINGS

The present invention will be better understood with reference to the following description taken in conjunction with accompanying drawings in which identical or like reference signs designate identical or like components. The accompanying drawings, together with the detailed description below, are incorporated into and form a part of the specification and serve to illustrate, by way of example, preferred embodiments of the present invention and to explain the principle and advantages of the present invention. In the accompanying drawings:

FIG. 1 shows a method for determining the padding length of an image in an image filtering direction during an image filtering according to an embodiment of the present invention;

FIG. 2 is flow chart showing the processing of obtaining the aliasing effect function of a frequency domain filter according to an embodiment of the present invention;

FIG. 3 shows an aliasing effect function obtained with respect to a Butterworth filter according to an embodiment of the present invention;

FIG. 4 is a flow chart showing the processing of determining a padding length based on an aliasing effect function according to an embodiment of the present invention;

FIG. 5 is a flow chart showing an image processing method according to an embodiment of the present invention;

FIG. 6 is a detailed flow chart of a filtering processing according to an embodiment of the present invention;

FIG. 7 is a flow chart showing an image processing method including the step of determining whether or not there is a need of expanding an image according to an embodiment of the present invention;

FIG. 8 is a flow chart showing the processing of determining whether to expand an image according to a padding length according to an embodiment of the present invention;

FIG. 9 shows an apparatus for determining the padding length of an image in an image filtering direction according to an embodiment of the present invention;

FIG. 10 is a schematic diagram illustrating the structure of an aliasing effect function obtaining unit according to an embodiment of the present invention;

FIG. 11 is a schematic diagram illustrating the structure of a padding length determination unit 1100 according to an embodiment of the present invention;

FIG. 12 is a schematic diagram illustrating the structure of an image processing apparatus 1200 according to an embodiment of the present invention;

FIG. 13 is a schematic diagram illustrating the structure of an image processing apparatus 1300 according to an embodiment of the present invention;

FIG. 14 is a structural diagram showing a determination unit according to an embodiment of the present invention.

FIG. 15 is a block diagram showing the exemplary structure of a general personal computer capable of realizing the methods and/or apparatuses provided in embodiments of the present invention.

### DETAILED DESCRIPTION

A simplified summary of the present invention is given below to provide a basic understanding of some aspects of the present invention. It should be appreciated that the summary, which is not an exhaustive overview of the present invention, is not intended to identify the key or critical parts of the present invention or limit the scope of the present invention, but merely to present some concepts in a simplified form as a prelude to the more detailed description that is discussed later.

In the technical scheme of the present invention, there is provided a method and apparatus for determining a padding length during an image filtering which substantially eliminate the aliasing effect caused by the filtering processing without causing a large amount of calculation, and an image filtering method and apparatus using the foregoing method and apparatus.

Since no overlong padding length (e.g. the foregoing padding length A−1 or B−1) is used in filtering the image, the quality of the image is substantially prevented from being deteriorated by the aliasing effect caused by the filtering processing while the amount of calculation is kept small.

In view of this, in one aspect, an embodiment of the present invention provides an apparatus for determining the padding length of an image in an image filtering direction. The apparatus for determining the padding length of an image in an image filtering direction may include an aliasing effect function obtaining unit for obtaining an aliasing effect function of a frequency domain filter for the image, wherein the aliasing effect function is a function representing spatial domain variation of an aliasing effect caused by a frequency domain filtering processing; and a padding length determination unit for determining the padding length for the image in the image filtering direction based on the aliasing effect function.

In another aspect, another embodiment of the present invention provides an image processing apparatus. The image processing apparatus may include: the foregoing apparatus for determining the padding length of an image in an image filtering direction; an image expansion unit configured to expand, in spatial domain, the image in the filtering direction according to the padding length; and a filtering unit configured to filter the expanded image.

Accordingly, in still another embodiment of the present invention, there is further provided a method for determining the padding length of an image in an image filtering direction. The method may include: obtaining an aliasing effect function of a frequency domain filter for the image; and determining the padding length of the image based on the aliasing effect function.

Additionally, in yet another embodiment of the present invention there is still provided an image processing method. The image processing method may include: determining a padding length of an image using the foregoing method; expanding, in spatial domain, the image in the filtering direction according to the padding length; and filtering the expanded image.

It is another object of the present invention to provide computer program codes which, when executed by a computer, cause the computer to execute the processing of the above-described methods, and to provide a computer-readable storage medium in which the computer program codes are stored and a computer program product.

The foregoing and other advantages of the present invention will become further apparent from the following detailed description of the most preferred embodiment, read in conjunction with the accompanying drawings.

Exemplary embodiments of the present invention are described below with reference to accompanying drawings. For the sake of clarity and simplicity, not all characteristics of practical implementation modes are described herein. However, it should be appreciated that in order to achieve a specific object of a developer, many determinations specific to the implementation mode of a practical embodiment, for example, a determination on the limitation conditions related to a system and a service which may change with implementation modes, should be made during the development process of the practical embodiment. Moreover, it also should be appreciated that the task of development, which may be extremely complicated and time-consuming, is, however, just a routine task for the skilled in the art who benefit from the content of this disclosure.

Additionally, it should be noted that in order to avoid the ambiguity caused by unnecessary details, only the structure of a device and/or processing steps that are closely related to the scheme of the present invention are illustrated in accompanying drawings, and the details not so relative to the present invention are saved.

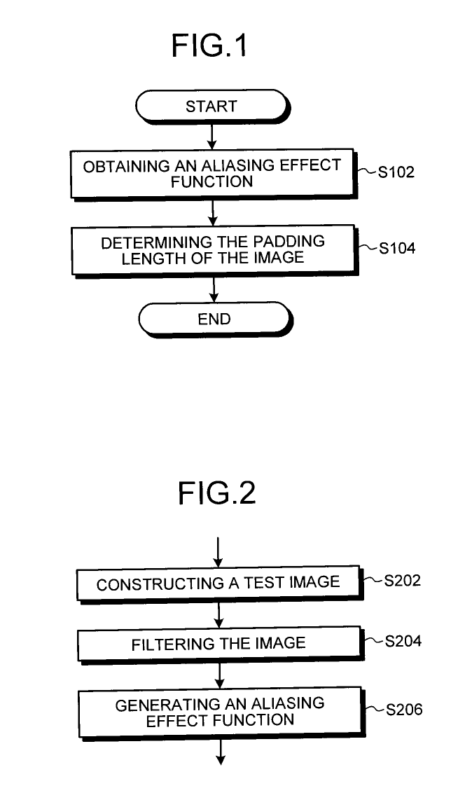

FIG. 1 shows a method for determining the padding length of an image in an image filtering direction during an image filtering according to an embodiment of the present invention.

As shown in FIG. 1, an aliasing effect function can be obtained in Step S102.

Specifically, an aliasing effect function of a frequency domain filter in an image filtering direction can be obtained for an image to be filtered in Step S102.

The aliasing effect function may be a function representing the spatial domain variation of an aliasing effect caused by the application of the filter to the image.

For instance, in the case where the filtering direction of an image is unidimensional (e.g. a filtering in the X direction, Y direction or Z direction of a three-dimensional image), the aliasing effect function for the image may be a unidimensional function in the filtering direction of the image (e.g. the X direction, Y direction or Z direction of the three-dimensional image). Or in the case where the filtering direction of an image is two-dimensional (e.g. a filtering in X direction and Y direction of a three-dimensional image) or multidimensional, the aliasing effect function for the image may be a two-dimensional (e.g. the X direction and the Y direction of the three-dimensional image) or multidimensional function in the filtering directions of the image.

As a preferred example, the filtering direction of an image may be, for example, the Z-axis direction of a three-dimensional image when the image is a medial image. In this case, the aliasing effect function may be a function in the Z axis of the medical image. The medical image may be an image formed by the data of an examinee obtained by a medial diagnostic imaging device which includes, but is not limited to: X-ray imaging diagnostic device, ultrasonic diagnostic imaging device, computed tomography (CT) device, magnetic resonance imaging (MRI) diagnostic device and positron emission tomography (PET) device and the like.

Moreover, the aliasing effect function may be obtained by many other methods.

For example, the aliasing effect function may be obtained by analyzing the variation of an image caused by the filtering processing.

Or the aliasing effect function may be directly obtained from the outside (e.g. a storage device in which the aliasing effect function for each filter is stored).

Then, the padding length of the image can be determined in Step S104.

Specifically, the padding length of the image may be determined based on the aliasing effect function.

Since the aliasing effect function can represent the spatial domain variation of an aliasing effect caused by a frequency domain filtering, the padding length in the spatial domain capable of limiting the aliasing effect to a negligible degree may be determined according to the aliasing effect function.

The padding length may be determined according to the aliasing effect function without expanding the image to an overlong length in the spatial length, thus reducing the amount of calculation resulting from the overlong image length during the image filtering process and substantially eliminating the influence of the aliasing effect. And the quality of the image is guaranteed since the influence of the aliasing effect is taken into consideration.

In an embodiment of the present invention, the aliasing effect function may be obtained by analyzing the variation of an image before and after the filtering processing.

Specifically, a filter may be applied to an image (e.g. an image with the same length as the image to be filtered in a filtering direction), and an aliasing effect function representing the magnitude of the aliasing effect caused by the filter may be obtained by analyzing the variation of the image caused by the filtering processing.

FIG. 2 is flow chart showing the processing of obtaining the aliasing effect function of a frequency domain filter according to an embodiment of the present invention.

As shown in FIG. 2, a test image is constructed in Step S202.

Specifically, a test image with the same length as the image to be filtered in the spatial domain is constructed.

The test image can be any form of image that has the same length with the image to be filtered in the spatial domain. For instance, the image to be filtered can be taken as the test image in some cases.

In a preferred embodiment of the present invention, in order to simplifying the calculation, the test image may be an image in the form of impulse function in the filtering direction.

In a more preferred embodiment, the test image may be an image meeting the following condition: in a filtering direction (e.g. the Z axis in the case of a unidimensional filtering), the image value at the first position is a unit intensity (e.g. 1), and the image values at other positions are 0.

Then, as shown in FIG. 2, the constructed test image is filtered in Step S204.

Specifically, the test image may be transformed to the frequency domain through Fourier transformation first.

Then the test image is filtered in the frequency domain.

For example, the test image may be filtered by multiplying the function of the filter by the function of the test image (equivalent to the implementation of a circular convolution in the spatial domain).

Then the filtered test image may be transformed back to the spatial domain through an inverse Fourier transformation.

Thus a filtering processing on the test image in the frequency domain is implemented.

Then, the aliasing effect function is obtained based on the variation of the test image caused by the filtering processing in Step S206.

As can be understood, the test image subjected to an inverse transformation is unchanged (for example, the test image may be still in the form of impulse function) if no filtering of it is carried out in the frequency domain.

However, if the test image is filtered in the frequency domain, the test image can be smoothed, and on the other hand, the image values of the test image subjected to the inverse transformation at different positions of the spatial domain are changed when the aliasing effect resulting from the filtering processing is transformed back to the spatial domain.

Thus, an aliasing effect function for representing the spatial domain variation of an aliasing effect caused by a frequency domain filtering may be determined according to the variations of the image values of the filtered test image at different positions of the spatial domain.

As mentioned above, in the case where a test image is in the form of impulse function (wherein the intensity of the first pixel of the test image is a unit intensity 1 and the intensities of the other pixels of the test image are all 0), the test image subjected to an inverse transformation can reflect the variations of different positions in the image caused by a filtering processing in a relatively intuitive manner. Therefore, an aliasing effect function can be obtained simply and intuitively according to the variation.

The foregoing description on the determination of an aliasing effect function using a test image in the form of impulse function is merely an example of the present invention but not a limitation to the present invention. In fact, the test image can be in any other form.

For example, in the case where the test image is in another form, an aliasing effect function may be determined according to the variation of the image value of each position in the test image caused by a filtering processing.

Specifically, the variation of the image value of each position in the test image caused by a filtering processing is first calculated and the subjected to a mathematical treatment (e.g. a parsing processing) to determine an aliasing effect function.

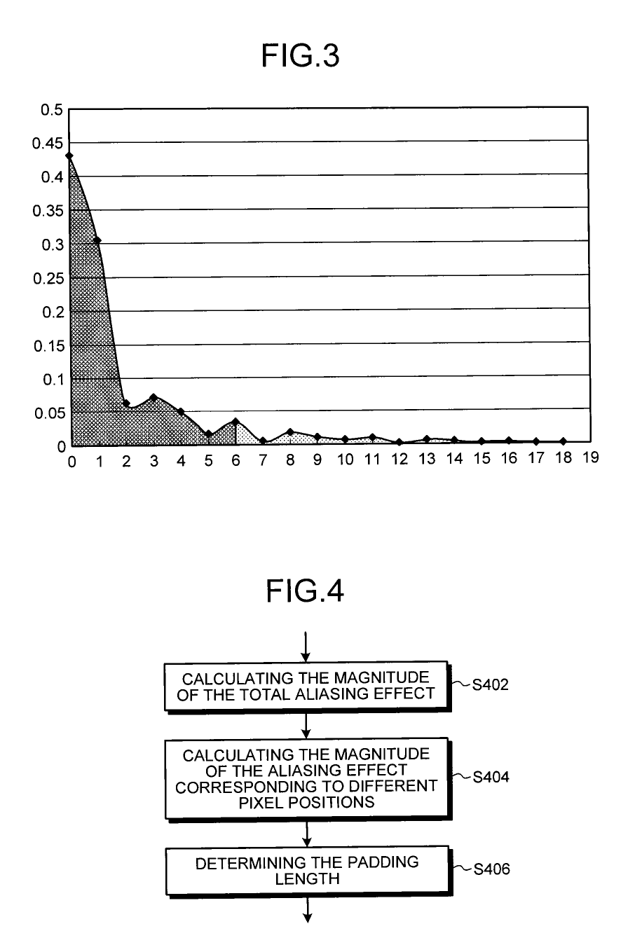

FIG. 3 shows an aliasing effect function obtained with respect to a Butterworth filter according to an embodiment of the present invention.

It should be noted that the aliasing effect function shown in FIG. 3 is merely an example of the present invention but not a limitation to the present invention, and an aliasing effect function with respect to the Butterworth filter may be in any other appropriate form that is capable of reflecting the distribution of the magnitude of the aliasing effect in the spatial domain.

The aliasing effect function shown in FIG. 3 is capable of presenting the distribution of the magnitude of an aliasing effect in the spatial domain. In FIG. 3, the horizontal axis represents image parts at different distances away from the filtered image part in the spatial domain, the vertical axis represents the magnitude of the aliasing effect corresponding to the image parts, and the area surrounded by a curve and the horizontal axis is related to the magnitude of the aliasing effect.

Therefore, the magnitude of the aliasing effect corresponding to different distances can be determined based on FIG. 3, and the aliasing effect caused by the filtering in the frequency domain can be correspondingly eliminated by expending an image to a corresponding distance and padding the corresponding position with an appropriate value (e.g. a value 0).

In existing technology, the aliasing effect is eliminated by eliminating possible aliasing items completely by expanding an image to the length of the filter and padding the expanded position with an image value 0.

Although the aliasing effect can be eliminated in this way, the amount of calculation is large since the expanded image should be subjected to a Fourier transformation and an inverse Fourier transform.

While in an embodiment of the present invention, the padding length capable of substantially eliminating the aliasing effect is determined based on an obtained aliasing effect function. Using such relatively short padding length to expand and filter an image can substantially eliminate the aliasing effect resulted from the filtering processing while effectively reducing the amount of calculation.

The determination of the padding length based on an aliasing effect function can be achieved in any appropriate way.

FIG. 4 is flow chart of the determination of a padding length based on an aliasing effect function according to an embodiment of the present invention.

As shown in FIG. 4, the magnitude of the total aliasing effect is calculated according to the aliasing effect function in Step S402.

For instance, in the case where the aliasing effect function is as shown in FIG. 3, the aliasing effect function may be integrated in the whole length range of the image (e.g. a length range corresponding to the length of the filtered image) to obtain the magnitude of the total aliasing effect.

Then, the magnitude of the aliasing effect generated at different image positions (that is, positions at different distances away from the filtered image part) of the image may be calculated according to the aliasing effect function in Step S404.

For instance, in the case where the aliasing effect function is as shown in FIG. 3, the aliasing effect generated at different positions (that is, positions at different distances way from the filtered image part) of the image may be calculated.

Specifically, the magnitude of the aliasing effect at a position of the image may be obtained by integrating the aliasing effect function with respect to the position.

Then, the padding length is determined according to the ratio of the aliasing effect corresponding to respective image positions to the total aliasing effect.

Specifically, the ratio of the aliasing effect corresponding to respective image positions to the total aliasing effect may be calculated first. Then the distance obtained when the ratio exceeds a predetermined threshold is taken as the padding length, wherein the predetermined threshold may be the following values that are predetermined as needed: 85%, 90%, 95%, 96%, 97%, 98% or 99% or the like.

For instance, it can be seen in the embodiment shown in FIG. 3 that the aliasing effect generated at six positions accounts for 95% of the total aliasing effect. Therefore, in the case where the threshold is set to be 95%, the padding length of an image may be set to be 6 and the image is expanded by six positions, the value at each of which is set to be a value 0. Then, after the expanded image is transformed to the frequency domain, the total aliasing effect caused at the six positions is 0. In this way, 95% of the aliasing effect caused by the filtering processing is eliminated, and as a consequence, the aliasing effect caused by the filtering in the frequency domain is substantially eliminated.

Through the processing above, a padding length capable of substantially eliminating an aliasing effect (e.g. 95% in the foregoing embodiment) can be determined without expanding the image to the length of the whole image, thus reducing the amount of calculation in the subsequent filtering processing.

By using the foregoing method for determining the padding length of an image, an image processing method is further provided in an embodiment of the present invention which is capable of effectively reducing the amount of calculation and substantially eliminating the aliasing effect.

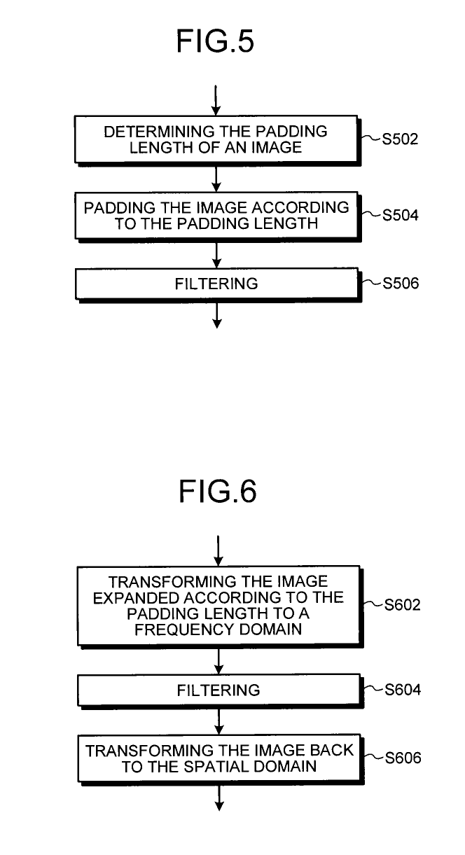

FIG. 5 is a flow chart of an image processing method according to an embodiment of the present invention.

As shown in FIG. 5, the padding length of an image may be determined in Step S502.

For instance, the padding length of an image may be determined using the method for determining the padding length of an image provided in the foregoing embodiment.

Then, the image may be expanded according to the padding length in Step S504.

Specifically, in the spatial domain, the image may be expanded and padded from the ending position thereof in the filtering direction of the image according to the padding length.

The image value of the expanded position of the image may be padded with 0. In this case, the magnitude of the aliasing effect generated at the expanded image positions during the filtering processing of the image is 0.

Although the image value of the expanded image position is set to be 0 in the foregoing description, the present invention is not limited to the foregoing description which is merely an example of the present invention. In fact, any other appropriate image value that is capable of effectively weakening the influence of the aliasing effect may be set for the expanded position.

For instance, in another embodiment of the present invention, the image value of the expanded positions of the image may also be set to be the image value of the expanded border of the image. In this case, the aliasing effect generated at the expanded positions of the image should not be 0. As the expanded positions of the image are padded with the border value of the expanded border, the aliasing effect may lead to an enhancement at the border of the image but no interference is caused to the main body of the image. Thus, the influence caused by the aliasing effect may also be effectively reduced in this case.

Besides, the foregoing image value for padding may be any other appropriate image parameter value, for example, a gray value.

Then, the expanded image may be filtered in Step S506.

As the image is specifically expanded, the filtering on the expanded image substantially eliminates the aliasing effect and, on the other hand, the amount of calculation is reduced.

FIG. 6 is a detailed flow chart of a filtering processing according to an embodiment of the present invention;

As shown in FIG. 6, the image expanded according to the padding length may be transformed to the frequency domain through a Fourier transformation in Step S602.

Since a short padding length is predetermined in this embodiment and the image is expanded according to the padding length, the amount of calculation may be reduced.

Then, the image may be filtered in the frequency domain using a frequency domain filter in Step S604.

As a short padding length is predetermined in this embodiment and the image is expanded according to the padding length, most of the aliasing effect may be eliminated during the filtering processing in the frequency domain. That is, there is substantially no aliasing effect resulting from the filtering processing.

Then, the filtered image may be transformed back to the spatial domain through an inverse Fourier transformation in Step S606.

As can be understood, since a short padding length is predetermined in this embodiment and the image is expanded according to the padding length, the amount of calculation may be reduced in the inverse Fourier transformation.

Therefore, the image processing method provided in the foregoing embodiment can realize a filtering processing on an image with a small amount of calculation and substantially no aliasing effect.

The present invention is not limited by the above-described image processing method for filtering an image, which is merely an example of the present invention. For instance, an image processing method provided in another embodiment of the present invention for filtering an image may further include a step of determining whether or not there is a need of expanding an image.

Specifically, after the padding length of an image is determined, a determination on whether or not there is a need of expanding an image may be made according to the determined padding length.

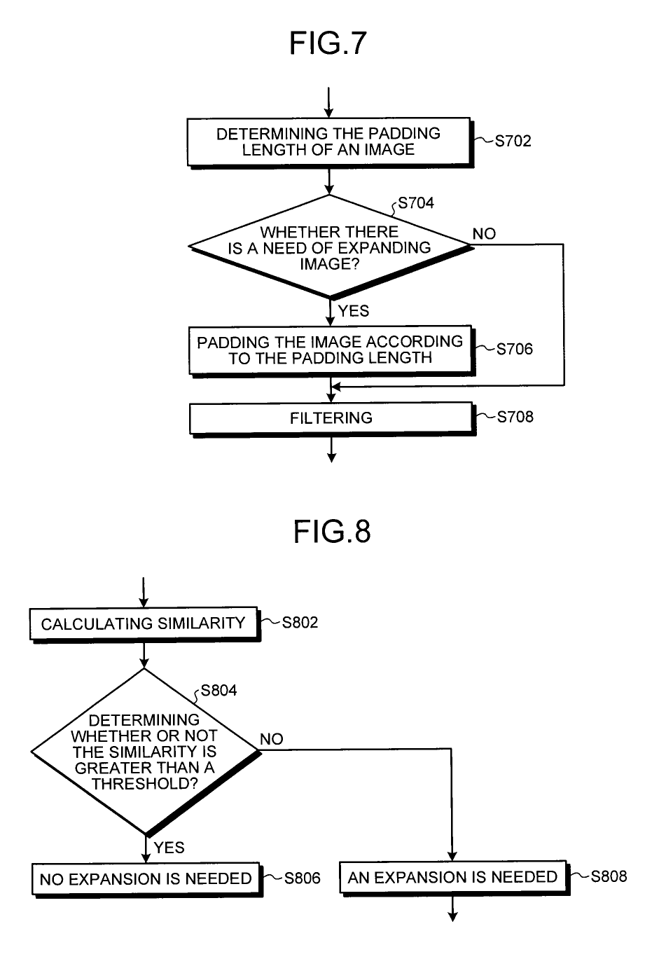

FIG. 7 is a flow chart of an image processing method including a step of determining whether or not there is a need of expanding an image according to an embodiment of the present invention.

As shown in FIG. 7, the padding length of an image may be determined in Step S702.

For instance, the padding length in the filtering direction of an image may be determined using the method provided in any of foregoing embodiments.

Then, a determination on whether or not there is a need of expanding the image may be made according to the determined padding length in Step S704 to avoid the aliasing effect.

Specifically, the aliasing effect is actually caused by the interference between the rear part and the head part of the image when the image is filtered in the frequency domain (equivalent to the implementation of a circular convolution in the spatial domain). Therefore, a determination on whether or not there is a need of expanding the image to avoid the aliasing effect may be made by determining whether or not the similarity between each image part that may cause the aliasing effect and each image part which may be interfered exceeds a threshold, wherein the threshold may be set based on empirical values and/or actual needs.

As shown in FIG. 7, if it is determined that no expansion is needed in Step S704, the image may be directly filtered in Step S708.

If it is determined that an expansion is needed in Step S704, the image may be padded according to the padding length in Step S706.

Then the expanded image may be filtered in Step S708.

Steps S702, S706 and S708 are similar to those S502, S504 and S506 in the foregoing embodiment described with reference to FIG. 5, so no more repeated description is given here to keep this specification concise.

It can be seen that by using the foregoing method, a further determination on whether the image needs to be expanded may be made after the padding length is determined, thus further reducing the amount of calculation in the case the image needs not to be expanded.

FIG. 8 is a flow chart of a determination on whether or not there is a need of expanding an image according to the padding length according to an embodiment of the present invention.

As shown in FIG. 8, the similarity between two parts of an image may be calculated in Step S802. Specifically, the similarity between an image part that may cause an aliasing effect and an image part that may be interfered by the aliasing effect is calculated.

More specifically, in this embodiment, the determined image part that causes most of the aliasing effect and corresponds to the padding length may be deemed as the image part that may cause the aliasing effect. Additionally, since the aliasing effect is caused by the multiplication of a filter function by an image function in frequency domain processing (equivalent to a circular convolution in spatial domain), the image part which is actually most seriously influenced by the aliasing effect is the first image part in the filtering direction (e.g. the Z axis if the filtering is carried out in the Z axis) in the spatial domain. Therefore, in this embodiment, the first image part in the filtering direction (the Z axis if the filtering is carried out in the Z axis) is taken as the image part influenced by the aliasing effect.

As can be seen, the determination of a high similarity (exceeding a threshold) between an image part causing an aliasing effect and an interfered image part indicates a small interference therebetween, then it can be determined that no expansion processing is needed; on the other hand, the determination of a low similarity (below a threshold) between an image part causing an aliasing effect and an interfered image part indicates a high interference (namely, a high aliasing effect) therebetween, then it can be determined that an expansion processing is needed in the spatial domain to eliminate the aliasing effect.

For instance, it is determined in the embodiment shown in FIG. 3 that the aliasing effect caused by the image parts at six positions of the image accounts for 95% of the total aliasing effect, that is, the image parts at the six positions may be taken as the ones causing the aliasing effect. Therefore, a determination on whether or not there is a need of expanding the image may be made according to the similarity between the image parts at the six positions and the image part at the first position.

Referring to FIG. 8, a determination on whether or not there is a need of expanding the image may be made according to the similarity in Step S804. Specifically, a determination on whether or not there is a need of expanding the image may be made by determining whether or not the similarity is greater than a threshold.

For instance, before the image is expanded, a determination on whether or not there is a need of expanding the image may be made by determining whether or not the similarity between the image part at the first position of the image and the image part at each of the six determined positions exceeds a threshold.

As a filtering processing in frequency domain is equivalent to a circular convolution in spatial domain, the six positions causing 95% of the aliasing effect determined in FIG. 3 are substantially the last six positions of the image in the spatial domain.

Thus, if the similarity between the image part at the first position of the image and the image part at each of the last six positions of the image exceeds a threshold, then it can be determined that the image parts at the last six positions of the image are similar to the image part at the first position of the image and thus cause a small aliasing effect, and it may be consequentially determined in Step S806 that no expansion processing is needed.

On the other hand, if the similarity between the image part at the first position of the image and the image part at each of the six positions of the image is smaller than a threshold, then it can be determined that there exists at least one image part causing an aliasing effect on the image among the last six positions of the image, and thus it may be determined in Step S808 that an expansion processing is needed.

Besides, the image part at the first position of the image may be compared with each of the image parts causing most of the aliasing effect (the image part corresponding to the padding length) in the foregoing description, it should be understood that the foregoing description is merely an example of the present invention but not a limitation to the present invention.

For instance, in the case of a medical images, considering the continuous slow change in the medical image in a filtering direction, the image parts causing most of an aliasing effect (the image parts at the last six positions in the example shown in FIG. 3) are considered as approximately identical, therefore, a determination on whether or not there is a need of expanding the image can be made according to the result of comparing the similarity between the image part at the first position of the image and any of the image parts at the six positions of the image (preferably, the image part at the last position) with a threshold. Calculating the similarity in this way can further reduce the amount of calculation and improve efficiency.

In the foregoing processing, the similarity between two parts of the image may be calculated in various ways.

For instance, in the case where the image is a two-dimensional image and the filtering direction is unidimensional (for example, a filtering in the X direction), the two image parts to be calculated may be two image strips captured in the X direction of the two-dimensional image.

For another instance, in the case where the image is a three-dimensional image and the filtering direction is unidimensional (for example, a filtering in the Z direction), the two image parts to be calculated may be two image slices captured in the Z direction of the three-dimensional image.

There are many methods provided for calculating the similarity of two image parts. In an embodiment of the present invention, the similarity of two image slices may be calculated according to the following formula:

$$S = \frac{1}{N} {\sum }_{i = 1}^{N} ( 1 - \frac{\vert {g}_{i} - {s}_{i} \vert}{Max ( {g}_{i} , {s}_{i} )} )$$

wherein S represents the similarity between the two image slices, N represents the number of the pixels in each image slice, gᵢ represents the parameter value of the ith pixel in the first image slice, and sᵢ represents the parameter value of the ith pixel in the second image slice. As mentioned above, the parameter value may be, for example, the gray value of a pixel.

The present invention is not limited by the foregoing description given based on an example of the calculation of the similarity between image slices, the formula above may be used to calculate the similarity between image strips or the like, no more repeated description is given herein to keep this specification concise.

There is also provided a corresponding apparatus in the embodiments of the present invention.

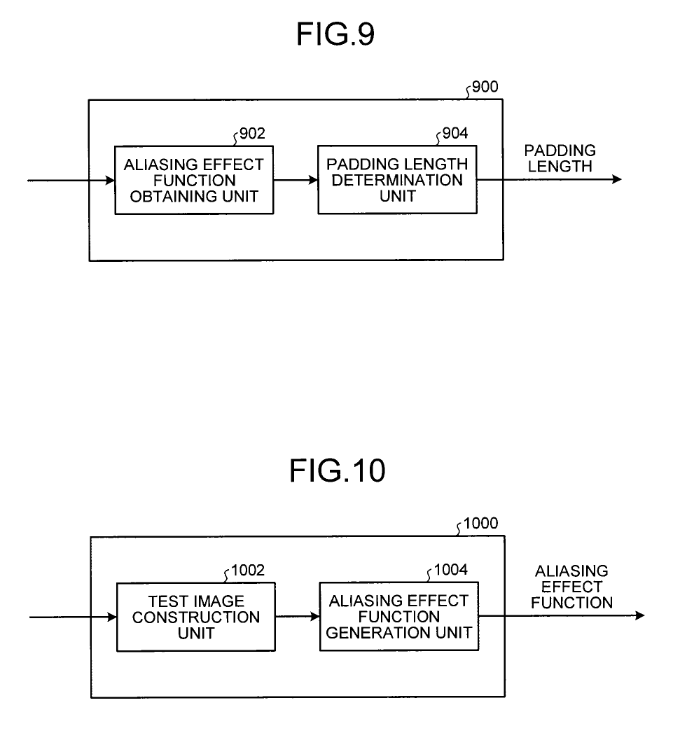

FIG. 9 shows an apparatus for determining the padding length of an image in an image filtering direction according to an embodiment of the present invention.

As shown in FIG. 9, the apparatus for determining the padding length of an image in an image filtering direction provided in this embodiment may include an aliasing effect function obtaining unit 902 and a padding length determination unit 904.

Specifically, the aliasing effect function obtaining unit 902 may obtain the aliasing effect function of a frequency domain filter for the image, and the padding length determination unit 904 may determine the padding length of the image in the image filtering direction based on the aliasing effect function. The aliasing effect function may be a function representing the spatial domain variation of an aliasing effect caused by a frequency domain filtering on the image.

The aliasing effect function obtaining unit 902 may obtain the aliasing effect function in many ways.

For instance, the aliasing effect function obtaining unit 902 may obtain the aliasing effect function by analyzing the variation of the image caused by a filtering processing,

Or the aliasing effect function obtaining unit 902 may directly obtain the aliasing effect function of a filter from the outside (e.g. a storage device in which the aliasing effect function of each filter is stored).

The padding length determination unit 904 may determine the padding length of the image based on the aliasing effect function. More specifically, the padding length determination unit 904 may determine, according to the aliasing effect function, a padding length in a spatial domain that is capable of limiting an aliasing effect to a negligible degree.

It can be seen that the apparatus provided in this embodiment for determining the padding length of an image in an image padding direction can determine the padding length of an image according to an aliasing effect function without expanding the image to an overlong length in a spatial domain. Therefore, the great amount of calculation resulting from an overlong image length during an image filtering may be reduced, and on the other hand, the influence caused by the aliasing effect may be substantially eliminated and thus the quality of the image may be guaranteed since the influence of the aliasing effect is taken into consideration.

In an embodiment of the present invention, the aliasing effect function obtaining unit 902 may obtain an aliasing effect function by analyzing the variation of an image before and after a filtering processing is performed.

FIG. 10 is a schematic diagram illustrating the structure of an aliasing effect function obtaining unit according to an embodiment of the present invention.

As shown in FIG. 10, according to this embodiment, an aliasing effect function obtaining unit 1000 may include a test image construction unit 1002 and an aliasing effect function generation unit 1004.

Specifically, the test image construction unit 1002 may be capable of constructing a test image with the same length as the image to be filtered, and the aliasing effect function generation unit 1004 may be capable of obtaining an aliasing effect function based on the variation of the test image caused by a filtering processing.

The test image can be any form of image that has the same length with the image to be filtered in the spatial domain. For instance, the image to be filtered can be taken as the test image in some cases.

In a preferred embodiment of the present invention, to simplify the calculation, the test image may be an image in the form of impulse function in the filtering direction.

In a more preferred embodiment, the test image may be an image meeting the following condition: in a filtering direction (e.g. the Z axis in the case of a unidimensional filtering), the image value at the first position may be a unit intensity (e.g. 1), and the image values at other positions may be 0.

The aliasing effect function generation unit 1004 may obtain, for the test image, an aliasing effect function based on the variation of the test image caused by a filtering processing. More specifically, the aliasing effect function generation unit 1004 may determine an aliasing effect function for representing the spatial domain variation of an aliasing effect caused by a frequency domain filtering according to the variation of the image values of the filtered test image at different positions in the spatial domain.

As mentioned above, in the case where a test image is in the form of impulse function (wherein the intensity of the first pixel of the test image is a unit intensity 1 and the intensities of the other pixels of the test image are 0), the test image subjected to an inverse transformation can reflect the variations of different positions in the image caused by a filtering processing in a relatively intuitive manner. Therefore, the aliasing effect function generation unit 1004 may obtain an aliasing effect function simply and intuitively according to the variation.

The foregoing description on the determination of an aliasing effect function using a test image in the form of impulse function is merely an example of the present invention but not a limitation to the present invention. In fact, the test image can be in any other form.

For example, in the case where the test image is in another form, the aliasing effect function generation unit 1004 may obtain an aliasing effect function according to the variation of the image value at each position in the test image caused by a filtering processing.

Specifically, the variation of the image value at each position in the test image caused by a filtering processing is first calculated and then subjected to a mathematical treatment (e.g. a parsing processing) to determine the aliasing effect function.

The padding length determination unit shown in FIG. 9 may be realized in many ways.

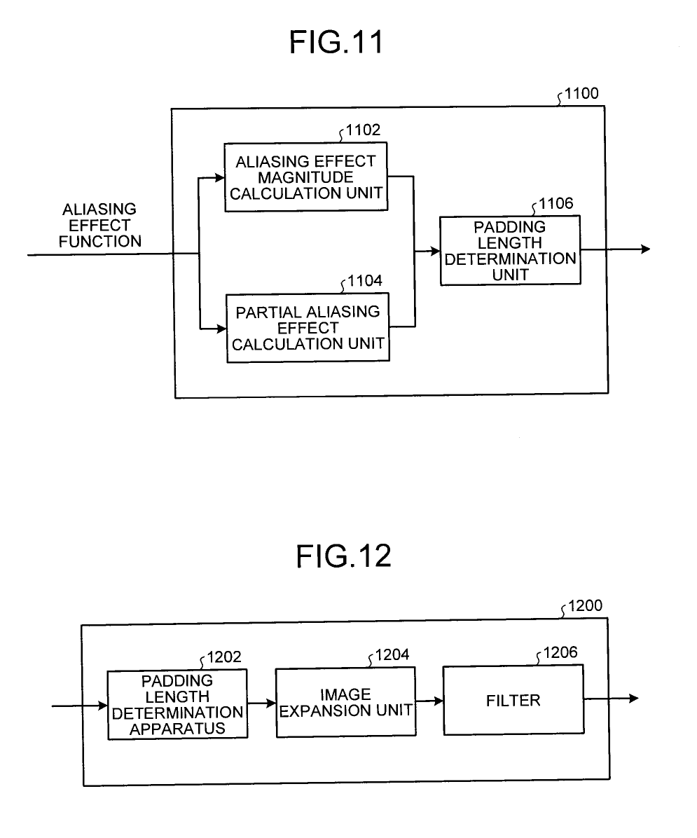

FIG. 11 is a schematic diagram illustrating the structure of a padding length determination unit 1100 according to an embodiment of the present invention.

As shown in FIG. 11, the padding length determination unit 1100 may include an aliasing effect magnitude calculation unit 1102, a partial aliasing effect calculation unit 1104 and a padding length determination unit 1106. Specifically, the aliasing effect magnitude calculation unit 1102 may calculate the magnitude of the total aliasing effect according to the aliasing effect function; the partial aliasing effect calculation unit 1104 may calculate, according to the aliasing effect function, the magnitude of the aliasing effect corresponding to different image positions; and the padding length determination unit 1106 may determine the padding length according to the ratio of the aliasing effect corresponding to the different image positions to the total aliasing effect.

For instance, in the case where the aliasing effect function is as shown in FIG. 3, the aliasing effect magnitude calculation unit 1102 may integrate the aliasing effect function in the whole length range of the image (e.g. a length range corresponding to the length of the filtering image) to obtain the magnitude of the total aliasing effect.

The partial aliasing effect calculation unit 1104 may obtain the magnitude of the aliasing effect at different positions by integrating the aliasing effect function with respect to the respective positions.

The padding length determination unit 1106 may calculate the ratio of the aliasing effect corresponding to respective image positions to the total aliasing effect first, and then take the distance obtained when the ratio exceeds a predetermined threshold as the padding length. The predetermined threshold may be the following values that are predetermined as needed: 85%, 90%, 95%, 96%, 97%, 98% or 99% or the like.

For instance, it can be seen in the embodiment shown in FIG. 3 that the aliasing effect generated at the position, the distance of which from the filtered image part is 6, accounts for 95% of the total aliasing effect. Therefore, in the case where the threshold is set to be 95%, the padding length determination unit 1100 may determine the padding length of the image to be 6 to eliminate the aliasing effect caused at the six positions. In this way, as high as 95% of the aliasing effect may be eliminated, and as a consequence, the aliasing effect resulting from the filtering in the frequency domain may be substantially eliminated.

In the above-described embodiment, a padding length capable of substantially eliminating an aliasing effect (e.g. 95% in the foregoing embodiment) can be determined without expanding the image to the length of the whole image, thus reducing the amount of calculation in the subsequent filtering processing.

Moreover, based on the foregoing apparatus for determining the padding length of an image in an image filtering direction, there is also provided an image processing apparatus which includes the foregoing apparatus and is capable of effectively reducing the amount of calculation and substantially eliminating the aliasing effect.

FIG. 12 is a schematic diagram illustrating the structure of an image processing apparatus 1200 according to an embodiment of the present invention.

As shown in FIG. 12, the image processing apparatus 12 may include a padding length determination apparatus 1202, an image expansion unit 1204 and a filter 1206.

Specifically, the padding length determination apparatus 1202 may be the apparatus for determining the padding length of an image provided in any of the foregoing embodiments.

The image expansion unit 1204 may expand, starting from the ending position of the image, the image in the filtering direction of the image according to the padding length.

The image value of the expanded image position may be padded with 0. In this case, the magnitude of the aliasing effect generated at the expanded image position during the filtering processing of the image is 0.

Although the image value of the expanded image positions of the image is set to be 0 in the foregoing description, it should be appreciated that the foregoing description is merely an example but not a limitation to the present invention. In fact, any other appropriate image value that is capable of effectively weakening the influence of an aliasing effect may be set for the expanded positions.

For instance, in another embodiment of the present invention, the image value of the expanded positions of the image may also be set to be the image value of the expanded border of the image. In this case, the aliasing effect generated at the expanded position of the image should not be 0. As the expanded positions of the image are padded with the border value of the expanded border of the image, the aliasing effect may lead to an enhancement at the border of the image but no interference is caused to the main body of the image. Thus, the influence of an aliasing effect may also be effectively weakened in this case.

Besides, the foregoing image value may be any other appropriate image parameter value, for example, a gray value.

The filter 1206 may filter the expanded image in frequency domain.

As the image is specifically expanded, the filtering on the expanded image substantially eliminates the aliasing effect and, on the other hand, the amount of calculation may be reduced.

The present invention is not limited to the above-described image processing apparatus for filtering an image, which is merely an example of the present invention. For instance, according to another embodiment of the present invention, there is provided an image processing apparatus for filtering an image which further comprises a determination unit for determining whether or not there is a need of expanding an image according to the padding length.

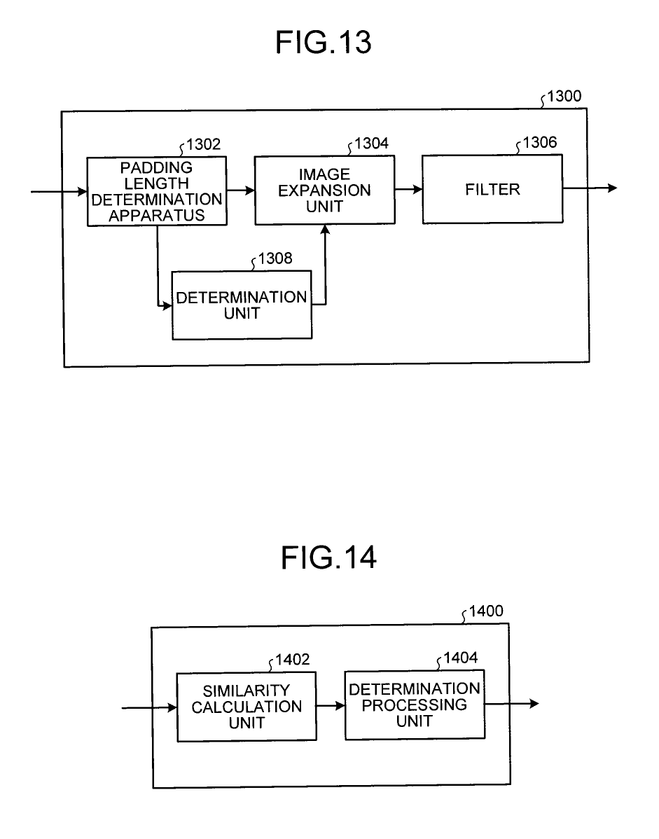

FIG. 13 is a schematic diagram illustrating the structure of an image processing apparatus 1300 according to an embodiment of the present invention.

As shown in FIG. 13, the image processing apparatus 1300 may include a padding length determination apparatus 1302, an image expansion unit 1304, a filter 1306 and a determination unit 1308.

The specific technical details of the padding length determination apparatus 1302, the image expansion unit 1304 and the filter 1306 may be understood with reference to those of the foregoing padding length determination apparatus 1202, image expansion unit 1204 and filter 1206 that are described in conjunction with FIG. 12.

The determination unit 1308 may make a determination on whether or not there is a need of expanding the image according to the padding length determined by the padding length determination unit 1302.

The determination unit 1308 may inform the image expansion unit 1304 to expand and pad the image according to the padding length if it determines that the image needs expanding or informs the image expansion unit 1304 not to expand the image but to transfer the image to the filter 1306 if it determines that the image needs no expanding.

It can be seen that by using the image processing apparatus 1300 provided in this embodiment, a further determination on whether the image needs to be expanded can be made after the padding length is determined, thus further reducing the amount of calculation for the image which needs not to be expended.

The determination unit provided in this embodiment may be realized in many appropriate ways.

FIG. 14 is a structural diagram of a determination unit according to an embodiment of the present invention.

As shown in FIG. 14, the determination unit 1400 provided in this embodiment may include a similarity calculation unit 1402 and a determination processing unit 1404.

The similarity calculation unit 1402 may calculate the similarity between an image part that may cause an aliasing effect and an image part that may be interfered by the aliasing effect.

In an embodiment of the present invention, the determined image part which causes most of the aliasing effect and corresponds to a padding length may be taken as an image part causing the aliasing effect, and the first image part in a filtering direction (e.g. the Z axis in a Z-axis filtering) may be taken as the image part interfered by the aliasing effect. Therefore, the similarity calculation unit 1402 may calculate the similarity between the first image part in the filtering direction (the Z axis in a Z-axis filtering) and each of the image parts corresponding to the padding length.

In the foregoing description, the similarity calculation unit 1402 compares an image part at the first position of the image with each of the image parts causing most of the aliasing effect (the image parts corresponding to the padding length), however, it should be appreciated that the foregoing description is merely an example of the present invention but not a limitation to the present invention.

For instance, in the case of a medical images, considering the continuous slow change in the medical image in a filtering direction, the image parts causing most of an aliasing effect (e.g. the image parts at the last six positions in the example shown in FIG. 3) may be considered approximately identical, and therefore the similarity calculation unit 1402 can just calculate the similarity between the image part at the first position of the image and any of the image parts at the six positions of the image (preferably, the image part at the last position). Calculating the similarity in this way can further reduce the amount of calculation and improve efficiency.

After the similarity is calculated, the determination processing unit 1404 may make a determination according to the calculated similarity.

Specifically, taking the embodiment shown in FIG. 3 as an example, if the similarity between the image part at the first position of the image and the image part at each of the six positions of the image exceeds a threshold, it can be determined that the image parts at the last six positions of the image are similar to the image part at the first position of the image and cause a small aliasing effect, and as a consequence, a determination can be made that no expansion processing is needed.

On the other hand, if the similarity between the image part at the first position of the image and the image part at one or more of the six positions of the image is smaller than the threshold, then it can be learned that there exists at least one image part causing an aliasing effect on the image at the last six positions of the image, and it is consequentially determined that an expansion processing is needed.

The similarity of two parts of the image may be calculated in various ways.

For instance, in the case where the image is a two-dimensional image and the filtering direction is unidimensional (for example, a filtering in the X direction), the two image parts to be calculated may be two image strips captured in the X direction of the two-dimensional image.

For another instance, in the case where the image is a three-dimensional image and the filtering direction is unidimensional (for example, a filtering in the Z direction), the two image parts to be calculated may be two image slices captured in the Z direction of the three-dimensional image.

There are many methods provided for calculating the similarity of two image parts. In an embodiment of the present invention, the similarity of two image slices may be calculated according to the following formula:

$$S = \frac{1}{N} {\sum }_{i = 1}^{N} ( 1 - \frac{\vert {g}_{i} - {s}_{i} \vert}{Max ( {g}_{i} , {s}_{i} )} )$$

wherein S represents the similarity of two image slices, N represents the number of the pixels in each image slice, gᵢ represents the parameter value of the ith pixel in the first image slice, and sᵢ represents the parameter value of the ith pixel in the second image slice. As mentioned above, the parameter value may be, for example, the gray value of a pixel.

The present invention is not limited by the foregoing description given based on an example of the calculation of the similarity of image slices, the formula above may be used to calculate the similarity of image strips or the like, no more repeated description is given herein to keep this specification concise.

Furthermore, the content that has been described in detail in the description of the foregoing methods is omitted in the detailed description of the apparatus to keep this specification concise. Therefore, more specific technical details of the apparatus can be understood with reference to the description of the foregoing methods.

In addition, it should be understood that the examples and embodiments described herein are only exemplary but not to be construed as limiting the present invention. In this specification, expressions ‘first’, ‘second’ and the like are merely for distinguishing the described characteristics literally so as to describe the present invention clearly and therefore should not considered definitive.

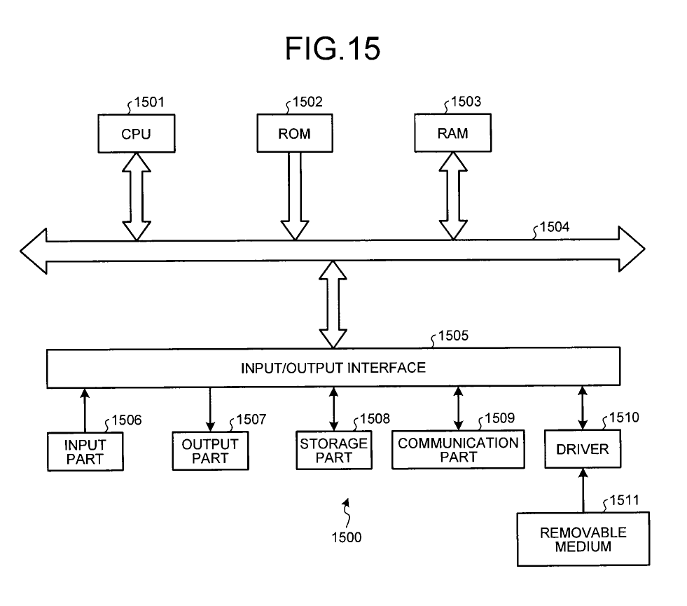

All modules and units in the foregoing apparatus can be configured through software, firmware, hardware or any combination thereof in a way (or by a means) that is well known by those skilled in the art and is therefore not repeatedly described herein. In the case where all modules and units in the foregoing apparatus are achieved through software or firmware, a program constituting the software is installed in a computer with a specific hardware structure (e.g. the general computer 1500 shown in FIG. 15) from a storage medium or network, wherein the computer, when installed with a program, is capable of realizing the functions of the program.

In FIG. 15, a central processing unit (CPU) 1501 executes various processing according to the program stored in a read-only memory (ROM) 1502 or a program loaded to a random access memory (RAM) 1503 from a memory part 1508. The data needed for the various processing of CPU 1501 may be stored in RAM 1503 as needed. CPU 1501, ROM 1502 and RAM 1503 are connected with each other via a bus 1504. An input/output 1505 is also connected with the bus 1504.

The following components are connected with the input/output 1505: an input part 1506 (including keyboard, mouse and the like), an output part 1507 (including displays such as cathode ray tube (CRT) and liquid crystal display (LCD) and loudspeaker), the memory part 1508 (including hard disk) and a communication part 1509 (including a network interface card such as LAN card and modem). The communication part 1509 realizes a communication via a network such as the Internet. If needed, a driver 1510 may also be connected with the input/output interface 1505, and a removable medium 1511, for example, a magnetic disc, an optical disc, a magnetic optical disc, a semiconductor memory and the like, may be installed on the driver 1501 to read a computer program therefrom and install the read computer program in the memory part 1508.

In the case where the foregoing series of processing is achieved through software, a program constituting the software is installed from a network such as the Internet or a storage medium such as the removable medium 1511.

It should be appreciated by those skilled in the art that the storage medium is not limited to the removable mediums 1511 shown in FIG. 15 in which programs are stored and which are distributed separated from the apparatus to provide the programs for users. Examples of the removable medium 1511 include magnetic disc (including soft disc (registered trademark)), optical disc (including compact disc read-only memory (CD-ROM) and digital video disk (DVD)), magnetic optical disc (including mini disc (MD) (registered trademark)), and semiconductor memory. Or the storage mediums may be the hard discs included in ROM 1502 and the storage part 1508 in which programs are stored and which are distributed to users along with the devices containing them.

The present invention further provides a program product stored with computer-readable instruction codes which, when read and executed by a computer, are capable of realizing the above-described methods provided in the embodiments of the present invention.

Correspondingly, a storage medium for storing the program product stored with computer-readable instruction codes is also included in the disclosure of the present invention. The storage medium includes but is not limited to soft disc, optical disc, magnetic optical disc, memory card, memory stick and the like.

At last, it should be noted that the terms “comprising”, “including” or any variant thereof are intended to reference a non-exclusive inclusion, such that a process, method, article or apparatus that comprises a list of elements includes not only those elements recited but also other elements not expressly listed or inherent to such process, method, article or apparatus. In addition, an element preceded by “comprises a” does not, without more constraints, preclude the existence of additional identical elements in the process, method, article, or apparatus that comprises the element.

Although the embodiments of the present invention are described in detail with reference to accompanying drawings, it should be understood that the implementation modes described above are merely illustrative of the present invention and should not be construed as limiting the present invention. Various modifications and variations can be devised by those skilled in this art on the above-described implementation modes without departing from the scope and spirit of the present invention. Therefore, the scope of the present invention is only limited by the appended claims and equivalents thereof.

What is claimed is:

1. An apparatus for determining a padding length of an image in an image filtering direction, comprising:
an aliasing effect function obtaining unit configured to obtain an aliasing effect function of a frequency domain filter for the image, wherein the aliasing effect function is a function representing spatial domain variation of an aliasing effect caused by a frequency domain filtering processing; and
a padding length determination unit configured to determine the padding length for the image in the image filtering direction based on the aliasing effect function.

2. The apparatus according to claim 1, wherein the aliasing effect function obtaining unit comprises:
a test image construction unit configured to construct a test image with the same length as the image; and
an aliasing effect function generation unit configured to generate the aliasing effect function based on variation of the test image caused by the filtering processing.

3. The apparatus according to claim 2, wherein the test image is an image in the following form: an image value at a first position in the image filtering direction is a unit value and image values at other positions are 0.

4. The apparatus according to claim 2, wherein the padding length determination unit comprises:
an aliasing effect magnitude calculation unit configured to calculate a magnitude of total aliasing effect according to the aliasing effect function;
a partial aliasing effect calculation unit configured to calculate a magnitude of the aliasing effect corresponding to different positions in the image according to the aliasing effect function; and
a padding length determination unit configured to determine the padding length according to a ratio of the aliasing effect corresponding to the different positions to the total aliasing effect.

5. The apparatus according to claim 1, wherein the image is a medical image formed by data obtained by a medical diagnostic apparatus.

6. An image processing apparatus, comprising:
the apparatus for determining a padding length of an image in an image filtering direction of claim 1;
an image expansion unit configured to expand, in spatial domain, the image in the filtering direction according to the padding length; and
a filter configured to filter the expanded image.

7. The apparatus according to claim 6, further comprising:
a determination unit configured to determine whether or not there is a need of expanding the image according to the padding length.

8. The apparatus according to claim 7, wherein the determination unit comprises:
a similarity calculation unit configured to calculate a similarity between each image part influenced by an aliasing effect and each of image parts which cause the aliasing effect and correspond to the padding length; and
a determination processing unit configured to carry out the determination according to the calculated similarity.

9. The apparatus according to claim 8, wherein the similarity between two image parts is calculated according to the following formula or a mathematical transformation thereof:
$$S = \frac{1}{N} {\sum }_{i = 1}^{N} ( 1 - \frac{\vert {g}_{i} - {s}_{i} \vert}{Max ( {g}_{i} , {s}_{i} )} )$$
wherein S represents the similarity, N represents number of the pixels in each image part, gᵢ represents a parameter value of the ith pixel in one of the two image parts, and sᵢ represents a parameter value of the ith pixel in the other of the two image parts.

10. The apparatus according to claim 9, wherein the parameter value comprises gray value.

11. The image processing apparatus according to claim 6, wherein the image is a medical image formed by data obtained by a medical diagnostic apparatus.

12. A method for determining a padding length of an image in an image filtering direction, comprising:
obtaining an aliasing effect function of a frequency domain filter for the image, wherein the aliasing effect function is a function representing spatial domain variation of an aliasing effect caused by a frequency domain filtering processing; and
determining the padding length for the image in the image filtering direction based on the aliasing effect function.

13. The method according to claim 12, wherein obtaining the aliasing effect function of the frequency domain filter for the image comprises:
constructing a test image with the same length as the image;
filtering the test image; and
obtaining the aliasing effect function based on variation of the test image caused by the filtering processing.

14. The method according to claim 13, wherein the test image is an image in the following form: an image value at a first position in the image filtering direction is a unit value and image values at other positions are 0.

15. The method according to claim 12, wherein determining the padding length of the image based on the aliasing effect function comprises:
calculating a magnitude of total aliasing effect according to the aliasing effect function;
calculating a magnitude of the aliasing effect corresponding to different positions in the image according to the aliasing effect function; and
determining the padding length according to a ratio of the aliasing effect corresponding to the different positions to the total aliasing effect.

16. The method according to claim 12, wherein the image is a medical image formed by data obtained by a medical diagnostic apparatus.

17. An image processing method, comprising:
determining an padding length of an image using the method of claim 12;
expanding, in spatial domain, the image in a filtering direction according to the padding length; and
filtering the expanded image.

18. The method according to claim 17, further comprising:
determining whether or not there is a need of expanding the image according to the padding length.

19. The method according to claim 18, wherein determining whether or not there is a need of expanding the image according to the padding length comprises:
calculating a similarity between each image part influenced by the aliasing effect and each of image parts which cause the aliasing effect and correspond to the padding length;
determining that there is no need of expanding the image if each calculated similarity is greater than a threshold; and
determining that there is a need of expanding the image if each similarity is not greater than the threshold.

20. The method according to claim 19, wherein the similarity between two image parts is calculated according to the following formula or a mathematical transformation thereof:
$$S = \frac{1}{N} {\sum }_{i = 1}^{N} ( 1 - \frac{\vert {g}_{i} - {s}_{i} \vert}{Max ( {g}_{i} , {s}_{i} )} )$$
wherein S represents the similarity, N represents number of the pixels in each image part, gᵢ represents a image value of the ith pixel in one of the two image parts, and sᵢ represents the image value of the ith pixel in the other of the two image parts.
